(19) United States
(12) Patent Application Publication
(10) Pub. No.: US 2002/0023095 A1
(43) Pub. Date: Feb. 21, 2002

(54) Method, apparatus and system of school search

(76) Inventors: Shinji Baba, Tokyo (JP); Michiya Murakami, Kanagawa (JP); Naoya Sakakibara, Tokyo (JP); Yotaro Okiyama, Tokyo (JP); Seiji Notomi, Tokyo (JP); Yoshiaki Ohnishi, Tokyo (JP); Yoshikazu Sumiya, Kanagawa (JP)

Correspondence Address: Finnegan, Henderson, Farabow,, Garrett & Dunner, L.L.P., 1300 I Street, N.W., Washington, DC, 20005-3315, US

(21) Appl. No.: 09/915,395

(22) Filed: Jul. 27, 2001

(30) Foreign Application Priority Data
Jul. 28, 2000 (JP) 2000-228457

(51) Int. Cl. G06F 15/16; G06F 17/00; G06F 7/00

(52) U.S. Cl. 707/104.1; 709/217

(57) ABSTRACT

A school searching method and apparatus obtain an ability characteristic indicating the ability level of a searching student at the present curriculum stage, set a target condition at a target stage of the searching student, and search one or more route schools located at one or more intermediate stages between the present curriculum stage and the target stage, the route school to be searched fitting with the ability characteristic, and forming the target achieving course suitable for the searching student to reach the target condition. The present method and apparatus search, with the target stage as the starting point, in a direction reverse to the curriculum progressive direction, a route school fitting with the ability characteristic and suitable to the condition of the next stage. The desire condition of the searching student is further obtained, and the route school suitable for the desire condition is searched.

### BACKGROUND OF THE INVENTION

1. Field of the Invention

This invention relates to a computer method and apparatus for searching a school on behalf of a searching student, and more particularly to the method and apparatus for searching a school suitable for accomplishing the future objective of the searching student.

2. Description of the Related Art

Conventionally, when a student such as a middle school student or a high school student is preparing for the school of his or her choice, guidebooks which contain information of many schools, colleges and universities are used. If the information of such guidebooks is data based, the schools may be searched through the use of a computer. Furthermore, with the development of internet technology, by structuring the system for searching schools through access to information providers, the school searching becomes more convenient.

In the school searching through the use of a computer, if a school suitable for the future objective of the student preparing for the school of his or her choice is found, it is believed that useful information, which did not heretofore exist, can be furnished to the student. The future objective means more than simply the school to which the student advances at the next stage. For example, for a middle school student or high school student, the future objective may be their desired occupation after graduation from the college or the university. For example, for the middle school student, the future objective may be the university they wish to attend after graduation from the high school.

For the technology of this type, Japanese Patent Laid-Open Publication No.2000-90167 discloses a system for supporting the selection of an advanced course. In this system, when a user selects his or her occupation, a school suitable for that occupation may be indicated. In the conventional technology, it only teaches schools that fit with a particular occupation.

On the other hand, if information can be furnished, and this information facilitates understanding or grasping the content of a course from the present enrolment conditions for an appropriate school to reaching the future target, it is considered that such information will be convenient for and useful to the student preparing for the school of his or her choice. Especially, in reaching the target through a number of schools having a number of stages, if an appropriate course leading to the target can be grasped, further usefulness of this information may be expected.

### SUMMARY OF THE INVENTION

Under the above technical background, the object of the present invention is to provide an appropriate searching method and apparatus for finding a school in consideration of achieving the object of the searching student such as a student preparing for a school of his or her choice. This object is accomplished by a combination of characteristics described in independent claims. Also, the dependent claims provide further favorable aspects of the present invention.

A certain aspect of the present invention is the school searching method for searching information concerning schools conforming to the searching student. This method includes steps of: obtaining an ability characteristic indicating the ability level of the searching student in a current academic stage; setting a target condition in a target stage of the searching student; and searching at least one route school or intermediate school located at an intermediate academic stage between the current academic stage and the target stage, the route school conforming to the ability characteristic and forming a target achieving course suitable for the searching student to reach the target condition. The target stage and target condition are, for example, an employment stage and occupation or a university stage and university. According to the invention, a school is sought appropriate for the student to reach the target condition by using the ability of the searching student. Therefore, the information on an appropriate school for considering achievement of the object may be provided to the searching student.

Preferably, in the step of searching the route school, the present method searches the route school suitable for the ability characteristic as well as appropriate to the next stage condition, in consecutive reverse order to the academic advancing direction, with the target stage as the starting point. According to this aspect, the appropriate route school on the route of achieving the target can be effectively found. Especially, when there is a plurality of intermediate curriculum stages between the present curriculum stage and the target stage, the appropriate route schools respectively to such plurality of an intermediate curriculum stages can be found.

Preferably, in the step of searching the route school, with regard to the consecutive school group composed by schools belonging to a number of consecutive intermediate curriculum stages, when the lower stage school forming the consecutive school group fits with the above ability characteristic and also the upper stage school fits with the condition of the next stage, this method selects the schools in the consecutive school group as the route schools forming the target achieving course or route. The consecutive school group is, for example, a university and a high school attached to the university, the entrance examination to which is not required. According to this invention, the preferable process of this invention for achieving the target and searching appropriate schools can preferably be applied to the above consecutive school group.

Preferably, in the step of searching the route school, this method searches the route school based on easy-accessibility of the entire target achieving route which can be obtained from easy-accessibility to the next stage in each of plural stage movements from the current curriculum condition to the target condition. According to the invention, for the searching student, a route school with which overall achievement of the target is considered easy can be obtained. For example, (1) enrolment to the route school is difficult and access to the target from the route school is easy, and (2) enrolment to the route school is easy but access to the target from the route school is difficult. The easy accessibility to the entire target achieving route indicates which of two routes ((1) and (2)) is easy overall. By using such indication, an appropriate route school can be obtained.

Preferably, the method of this invention further includes the step of acquiring a desired condition indicating the desire of the searching student for the route school, and in the step of searching the route school, this method searches the route school conforming to the desired condition. The desired condition includes, for example, the condition regarding the location of the route school. According to the invention, not only the route school favorable to the achievement of the target but also accommodating the desire of the searching student is searched. For the searching student, useful information can be obtained to achieve the target through the environment satisfying his or her desire.

The invention is not limited to the aspect of the above school searching method. Another aspect or embodiment of the invention is, for example, a school searching apparatus, and for example, a school searching system. The school searching system may include a WWW server and database server for school searching, and may provide information to the searching student through the Internet. Also, another form of the invention is, for example, program and recording media storing the program to carry out the above invention.

The summary of the invention does not list all necessary characteristics of the invention and a sub-combination of these characteristics groups may also be an invention included within the scope of this invention.

### BRIEF EXPLANATION OF THE DRAWINGS

FIG. 1 shows a brief structure of the school searching system.

FIG. 2 is a flow chart showing the school search processing by the system in FIG. 1.

FIG. 3 shows the input display of personal information.

FIG. 4 shows the input display of searching conditions.

FIG. 5 shows the display of a list of search results.

FIGS. 6A and 6B show an example of detailed information displayed for the designated school.

FIG. 7 shows an example of the school evaluation as the detailed information displayed for the designated school.

FIGS. 8A, 8B and 8C show showing an example of questionnaires used in the system of FIG. 1.

FIGS. 9A and 9B show another example of questionnaires used in FIG. 1.

FIG. 10 shows the principle of school searching process characteristic to the present embodiment.

FIG. 11 is a part of the system of FIG. 1, which shows the elements mainly relating to the process characteristic to the present embodiment.

FIG. 12 is an example of the route school searching process and shows the process for searching a university as the route school.

FIG. 13 is an example of the route school searching process and shows the process for searching a high school as the route school.

FIG. 14 is an example of the route school searching process and shows the process for searching a middle school as the route school.

FIG. 15 is a flow chart for the searching process by the school searching system of FIG. 11.

FIG. 16 shows input display of the personal information.

FIG. 17 shows selective image of a desired type of occupation as the target condition.

FIG. 18 shows selective image of a desired type of occupation as the target condition.

FIG. 19 shows input image of a simulation condition.

FIG. 20 shows the display indicating the searching result of a university as the route school.

FIG. 21 shows the display indicating the searching result of a high school as the route school.

FIG. 22 shows the display indicating the searching result of a middle school as the route school.

FIG. 23 shows the display showing the result of simulation when the searching student is a high school student.

FIG. 24 shows the display showing the result of simulation when the searching student is a middle school student.

FIG. 25 shows the display showing the result of simulation when the searching student is a primary school student.

FIG. 26 shows the school search process covering the consecutive school group.

FIG. 27 shows an example of automatic searching process of target achieving course.

FIG. 28 shows an example of an automatic searching process for a target achieving course.

FIG. 29 shows an example of an automatic searching process for a target achieving course.

FIG. 30 indicates the principle of a searching process considering easy-accessibility.

FIG. 31 indicates the searching process according to the principle of FIG. 30.

### DESCRIPITON OF PREFERRED EMBODIMENTS

The invention is hereafter explained through an embodiment of the invention, but the embodiment does not limit the claims and all combinations of characteristics explained in the embodiment are not indispensable to the invention.

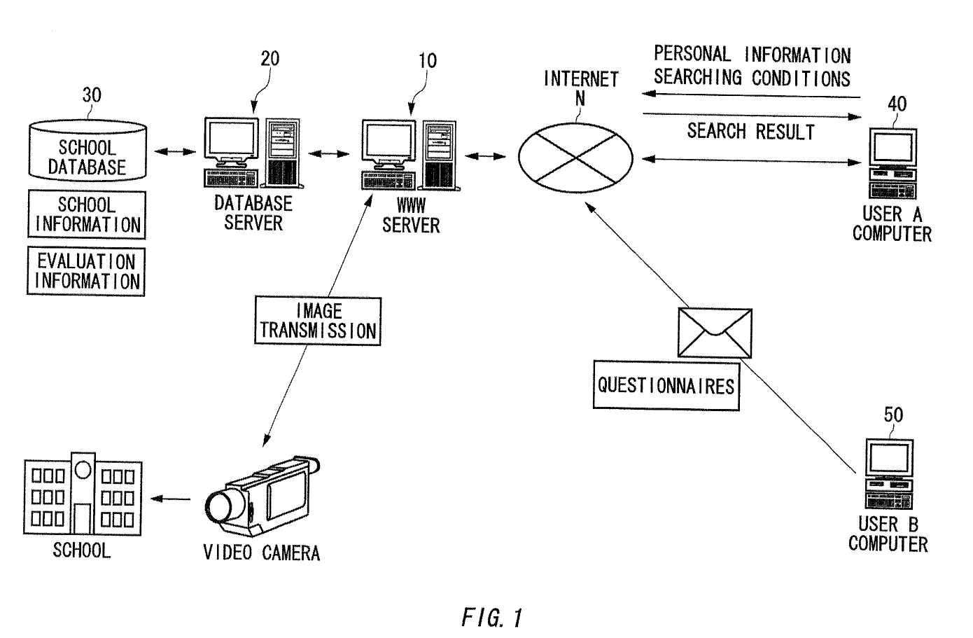

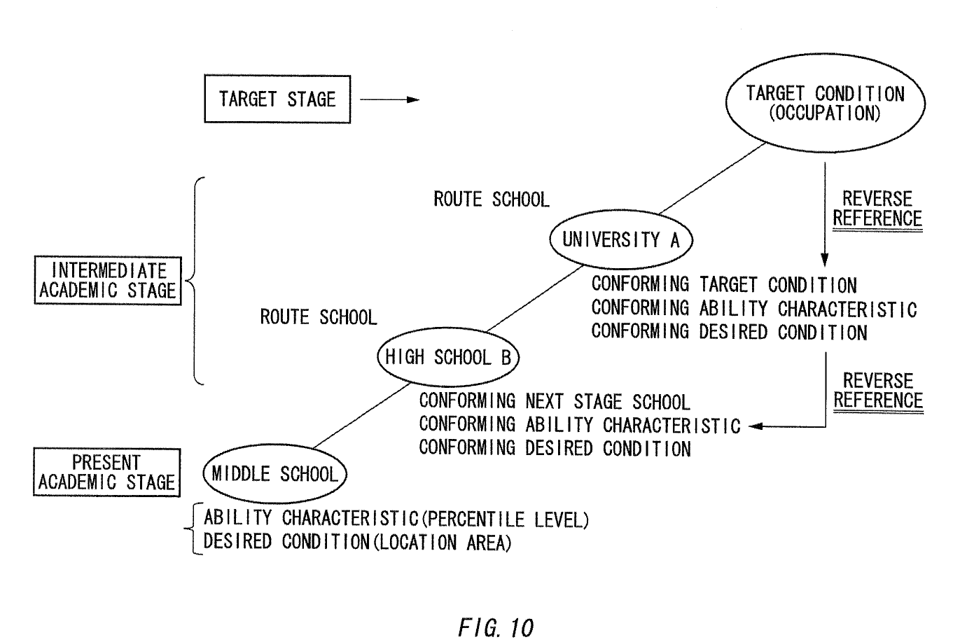

First, a summary of the entire school searching system to which this invention is applied will be explained by making reference to FIG. 1 through FIG. 9, and furthermore, the characteristic configuration of the invention will be explained by making reference to FIG. 10 et seq.

FIG. 1 shows the overall summary of the school searching system 1 (the school navigator system). The school searching system 1 includes a WWW server 10 anda database server 20 provided for school searching. The database server 20 is connected to aschool database 30 which stores the information of many schools used for search processing and evaluation information of each school.

The WWW server 10 is connected to user terminals 40, 50 through the Internet N. User A of the user terminal 40 searches schools by utilizing the searching system 1. On the other hand, the user B of the user terminal 50 responds to a questionnaire requested by the searching system 1. Two terminals are indicated here to facilitate the explanation, but actually there are many terminals. Also, the user may of course search the schools or respond to questionnaires by utilizing a single terminal.

The WWW server 10 has functions such as acquisition of searching conditions, acquisition of replies to questionnaires, and offering the searching results to users. The database server 20 extracts subject data corresponding to the searching conditions using the school database 30. Also, the data server 20 creates and updates the evaluation information of the school based on replies to the questionnaires.

The WWW server 10 further receives images taken of the inside of the school from video cameras provided in schools. The image may be a still image or an image in motion (motion picture). The WWW server 10 provides images of schools at the request of the user terminal 40.

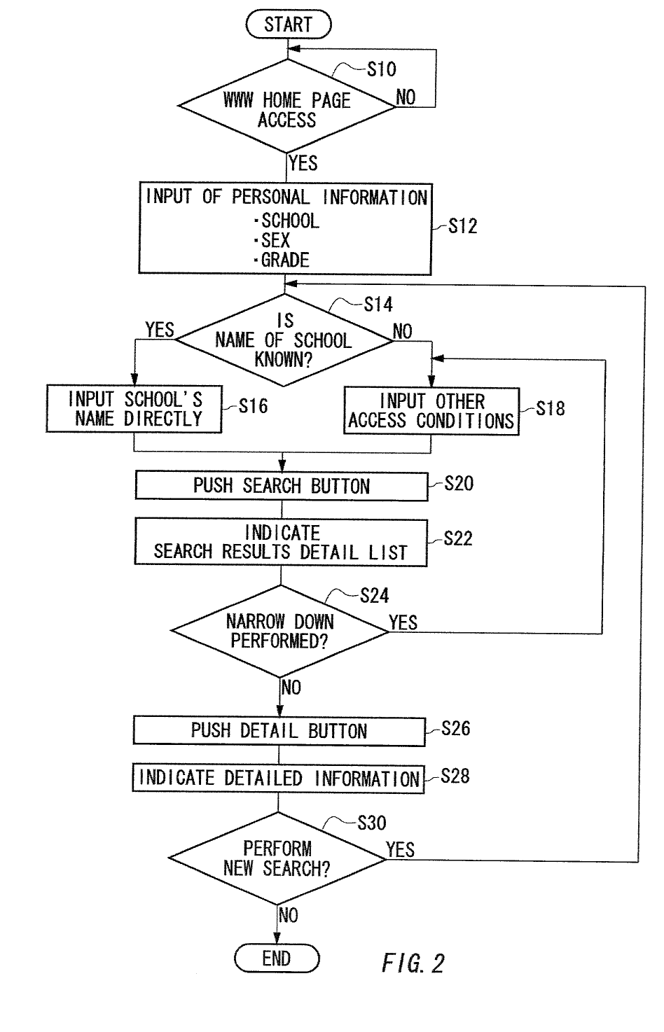

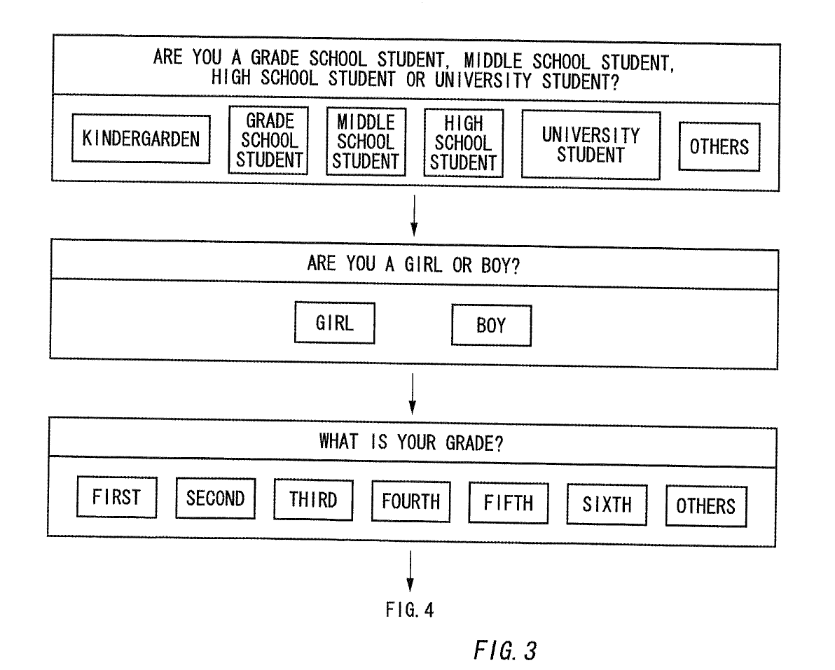

The process of the school search by the searching system 1 will be explained by making reference to FIG. 2 through FIG. 6. FIG. 2 is a flow chart of the school search process. The user terminal 40 has access to the WWW server 10 (S10), and performs a process of inputting personal information (S12). The term personal means the user of the user terminal 40, and searching student. Under the control of the WWW server 10, the input display of FIG. 3 appears on the user terminal 40. The personal information is input by the user, and input data is sent to the WWW server 10.

Next, the searching condition is input by the user. If the name of a school to be searched had already been determined (S14, Yes), the name of school is input directly as the searching condition (S16). On the other hand, if the name of a school is not determined (S14, No), the searching conditions showing characteristics of the desired school are input (S18).

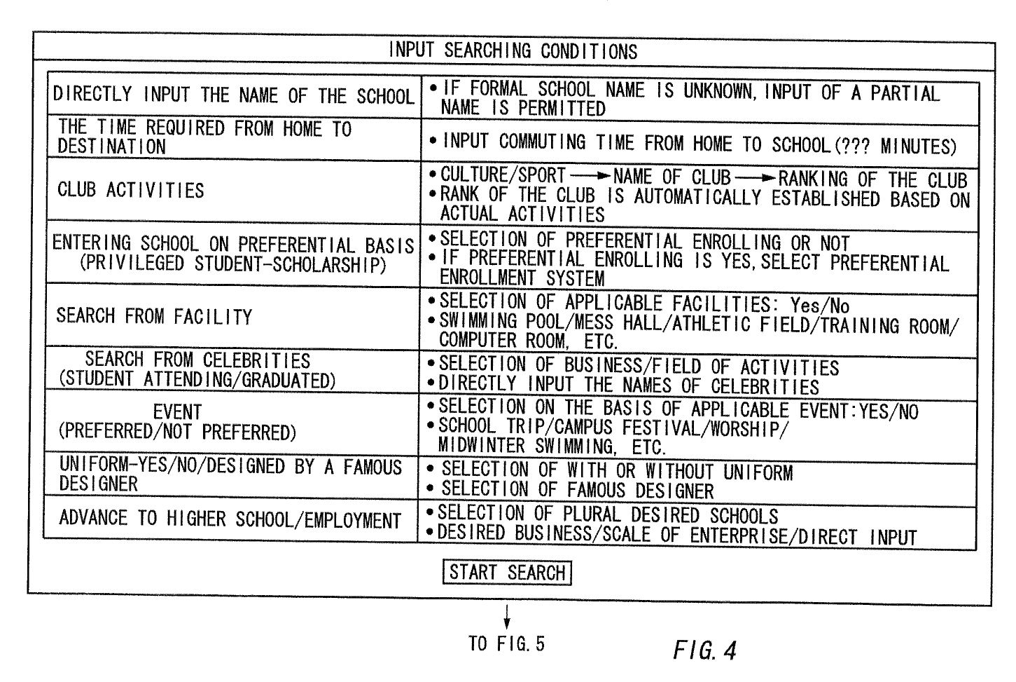

FIG. 4 indicates items to be used as searching conditions. The name of a school is input in the uppermost column when the name of a school is already known. If the name of a school is unknown, other conditions are input. A number of conditions may be input.

In S14 through S18 inclusive, the input screen of searching condition is shown on the user terminal 40. The searching condition is input by the user. Furthermore, the user presses the searching button provided on the screen (S20). In doing so, the searching condition is sent to the WWW server 10. The WWW server 10 then sends the personal information and searching condition to a database server 20 with a searching demand. A school database 30 has school information corresponding to various searching conditions which may be input (FIG. 4). A database server 20 searches and extracts the school corresponding to the searching condition from a school database 30. When plural searching conditions are designated, compounded searches are performed.

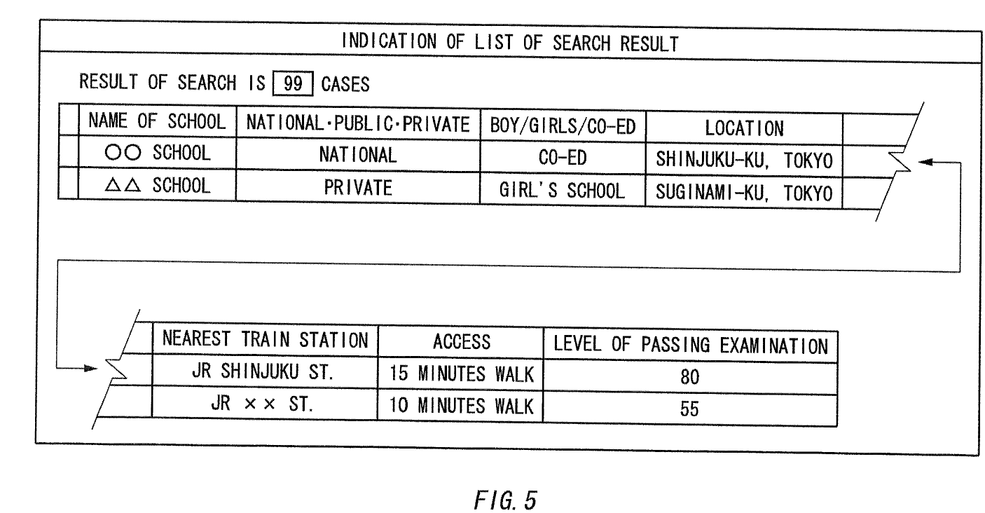

The database server 20 sends the school information obtained as a result of the search to the WWW server 10. WWW server 10 processes, modifies and adjusts the information as the result of search to provide it to the user. Here, the detailed list of searching results shown in FIG. 5 is prepared in HTML form. Then, this searching result list is transmitted to and indicated on the user terminal 40 (S22).

When a large number of schools are obtained as the result of search, narrowing down is instructed depending on the user (S24, Yes), and by going back to S18, the searching condition is input again. When narrowing down is unnecessary (S24, No), the process of demanding detailed information is performed (S26). The user operates the terminal unit and designates the desired school from the list in FIG. 4, and pushes (clicks) the detailed button (not illustrated). The designated school is sent from the user terminal 40 to the WWW server 10. The WWW server 10 acquires the detailed information of the designated school from the database server 20 and sends this information to the user terminal 40. Then, the detailed information is indicated on the user terminal 40 (S28).

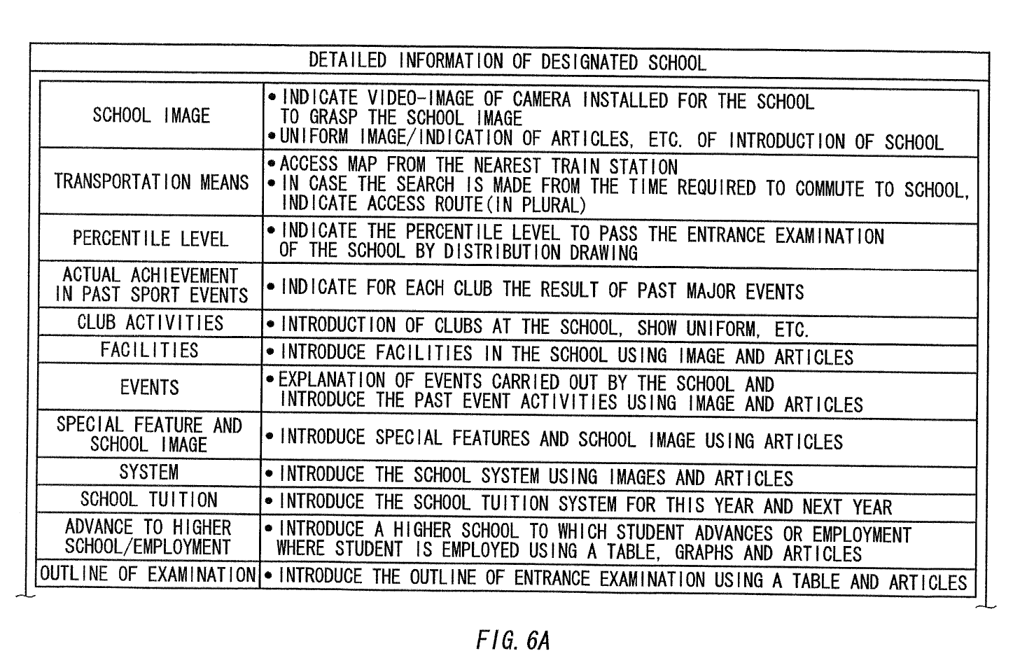

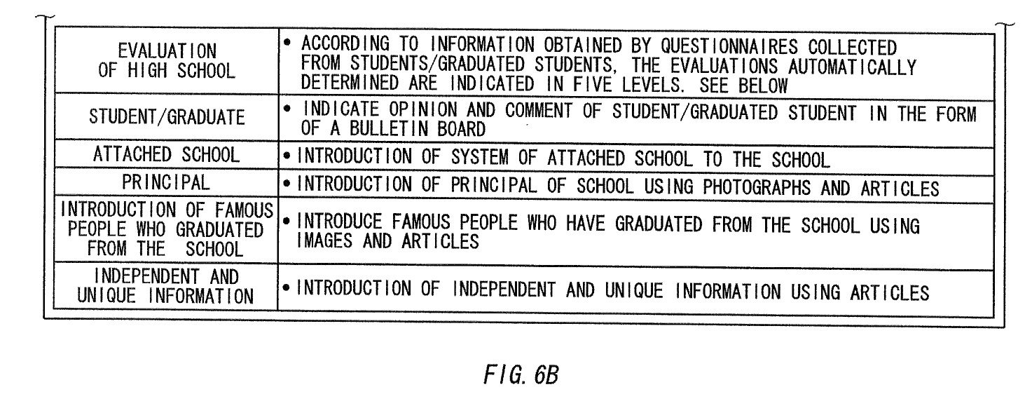

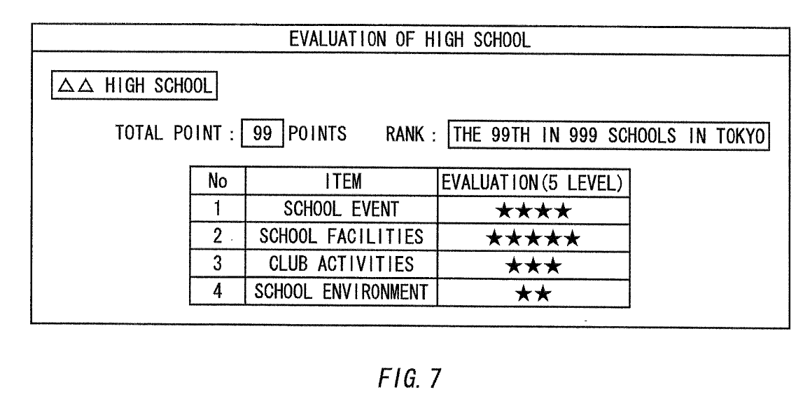

FIGS. 6A and 6B indicate the detailed information furnished with the present system 1. The detailed information comprises the text and image. The school image in the figure is the image obtained from the video camera installed at the school. Also, the evaluation of a high school, a high school student/graduate and independent information are the information obtained from the questionnaire hereafter stated, and these are also taken out from the school database 30. FIG. 7 is an example of display of the high school evaluation.

After the detailed information is displayed, when the new search is instructed by the user (S30, Yes), processing returns to S14. When the new search is not instructed (S30, No), the process is completed.

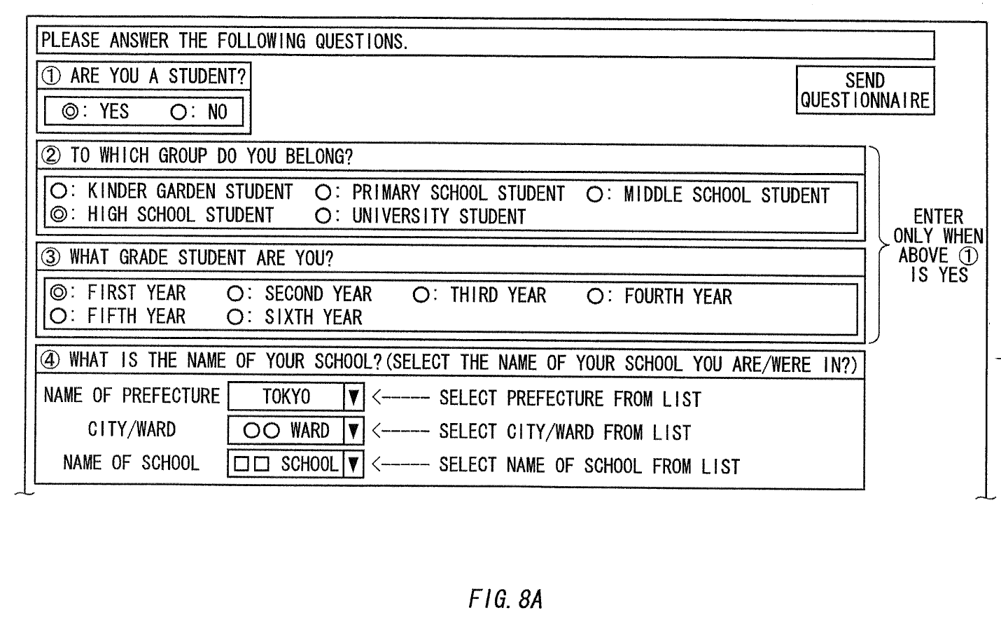

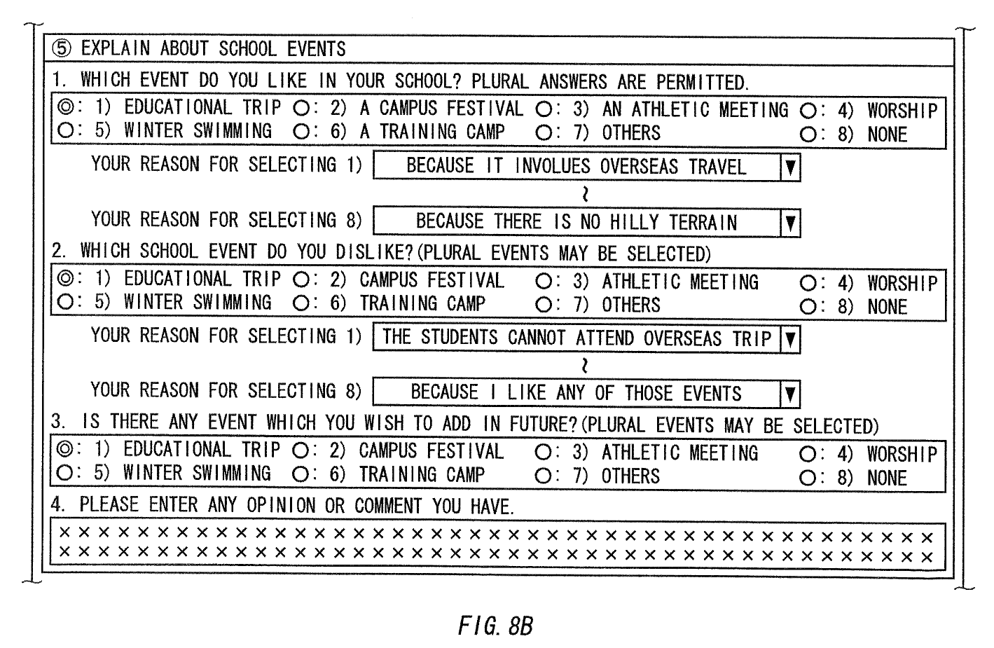

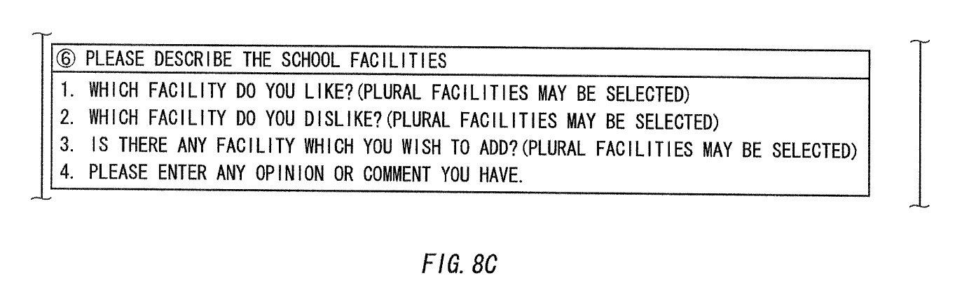

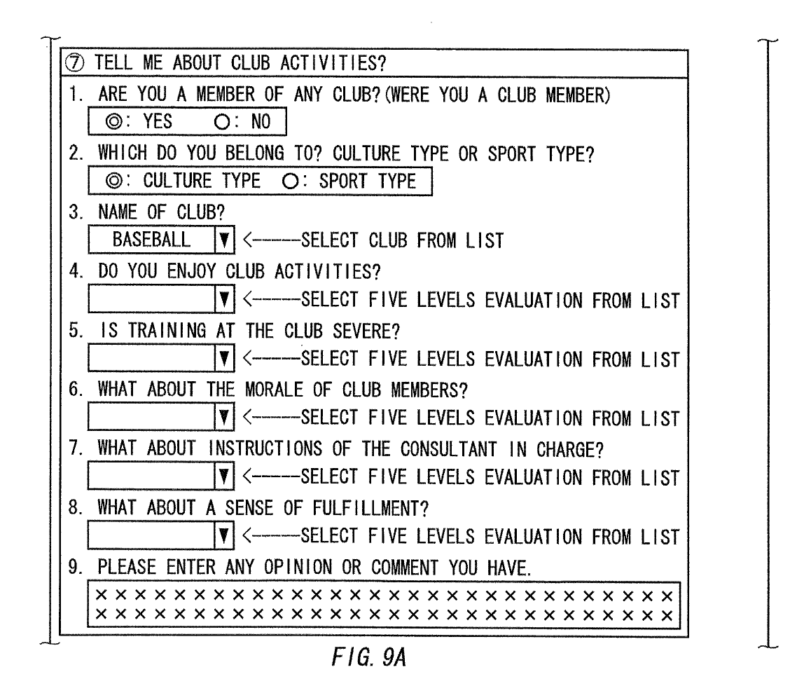

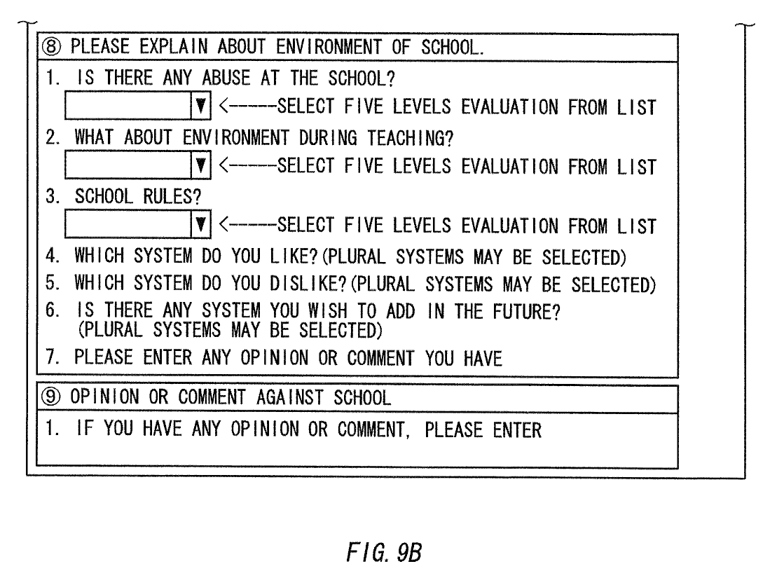

Returning to FIG. 1, the questionnaire related process by the present searching system is explained. A user terminal 50 accesses the WWW server 10 according to the instruction of the user B, and receives the questionnaire investigation sheet in HTML form. FIGS. 8A to 8C, FIGS. 9A and 9B are examples of the questionnaire investigation sheet. The user enters information regarding the school the user is attending or regarding the school graduated from in the questionnaire reply. The questionnaire investigation report after the entry is transmitted from the user terminal 50 to the WWW server 10. After the transmission is completed, “transmission completed” is notified to the user terminal 50.

The WWW server 10 transfers the questionnaire reply data to the database server 20. The questionnaire reply is stored in the school database 30. Also, based on the questionnaire reply, the evaluation of the school covered by the questionnaire is set. For example, the evaluation information exemplified in FIG. 7 is already stored in the school database 30. Evaluation ranking of each item reflects the total sum of points obtained from the questionnaire reply up to that time. Then, based on a new questionnaire, the evaluation point on each item is updated, and the evaluation ranking is also updated according to the evaluation point. Further, the total points of all items is updated and corresponding thereto, the determination of evaluation ranking of the school is changed. Namely, according to the questionnaire reply, the ranking fluctuates. The school evaluation information which is updated as above is provided or furnished to the user terminal 40 as the school search result through the WWW server 10.

Summary of the school search system (school navigator) is explained above. This searching system performs compounded or single searching processing of various types of searching conditions. Also, with simple operations of the computer, a search using various searching conditions is possible. Therefore, the user is able to efficiently find a school having their desired characteristics.

Furthermore, if a school image taken by a video camera installed at a school is provided by this searching system, the user is able to easily and accurately get an image of the school.

Furthermore, according to this searching system, school information is collected by the questionnaire investigation on the Internet. Also, the evaluation information is provided based on the questionnaire result. Therefore, information useful for getting a picture of the school objectively may be furnished based on the abundant information obtained through utilizing the Internet.

Next, the searching process of a route school suitable to accomplish the target of the searching student which is characteristic to the present embodiment will be explained.

FIG. 10 schematically depicts an example of the searching process of the route school. In this example, the searching student (student preparing for examination) is a middle school student, and accordingly, the present academic stage is a middle school. Also, in this example, the target stage is an employment stage, and target condition is an occupation. Between the target stage and the present academic stage, there are two academic stages, namely, a high school and university (the university includes a junior college and a vocational school, hereafter called the same in the present specification). The interim academic stage is called the “intermediate academic stage”. The searching student arrives at the target stage through a school at an intermediate academic stage. The school at these intermediate academic stages is called a “route school or intermediate school” hereafter.

In this embodiment, the route school appropriate for arriving at the target condition is searched. For the purpose of this searching process, the ability characteristic of the searching student is obtained, and target condition of the target stage is set. The ability characteristic is information indicating the ability level at the present academic stage. In this embodiment, a percentile (HENSACHI) is obtained as an example of the ability characteristic. Also, the route school conforming to the ability characteristic and forming the target achieving course which is appropriate for the searching student to attain the target condition (target occupation) may be sought.

Referring to an example of FIG. 10, the route school to be selected conforms to the ability characteristic and also conforms to the condition of the next stage. That is, a university A selected as a route school is the university which may be enrolled at the percentile level of the ability characteristic, and the university which is appropriate for advancing to an occupation of the next stage. Also, the high school B selected as a route school is a high school which may be enrolled at the percentile level, and also suitable to advance to the next stage condition (a university A). Therefore, the university A and high school B which are intermediate schools form the target achieving course appropriate to advancing to the target condition.

As stated above, with this embodiment, the ability characteristic of the target searching student is applied to the searching process of schools at a plurality of intermediate academic stages to search the school suitable to the ability characteristic, and further a school suitable to the target condition is searched. With such processing, the school suitable to achieve the target condition by using the ability of the searching student can be searched. Therefore, the useful school information may be furnished to the searching student for considering the achievement of the target.

Especially, with this embodiment, the route school or intermediate school may be searched by a reverse searching process which is explained hereafter.

First, a starting point of search is set at the target stage, and the route school at the university stage which is one stage prior to the starting point is searched. Here, the university suitable to the ability characteristic and suitable to advance to the condition of next stage that is the target stage is searched.

Next, a route school at the high school stage which is one stage prior to the university stage is searched. A high school suitable to the ability characteristic and suitable for advancing to the condition of the next stage which is the university selected already is searched.

Thus, the route schools are searched one after another in the reverse order of the academic advance direction with the target stage as the starting point.

By adopting the reverse processing, the route school or intermediate school can be found effectively. The school database stores information of many universities and high schools. There are also many combinations of universities and high schools. In trying to determine whether or not each of the many combinations forms the target achieving course of FIG. 10, a lot of arithmetic processing is required. On the other hand, such reverse processing does not require the processing of as many combinations. This is because a university is selected at first and a high school suitable for the selected university is selected next. Therefore, the amount of arithmetic processing is vastly reduced.

Also, in this embodiment, desired conditions of the searching student are preferably obtained in addition to the ability characteristic. The desired conditions are the information indicating the desire of the searching student with respect to the route school. As an example of desired conditions of this embodiment, the area in which a school is located is obtained. Then, in searching the route school, the school suitable for the desired condition is obtained. In this way, the route school accommodating the desire of the searching student, and not only favorable to the achieving target, can be obtained. For the searching student, useful information may be obtained to achieve the target through the environment to satisfy its desire.

In the example of FIG. 10, the searching student was a middle school student, but the searching student may be a grade school student or high school student. Also, the target stage and target condition are the employment stage or occupation, but they may be the university stage and a university. In that case, the searching student is a middle school student or a grade school student. Furthermore, the target stage and target condition may be the high school stage or a high school, and in that case, the searching student is a grade school student.

The ability characteristic is not limited to the percentile level, but may be other parameters. For example, if the target condition is a sports player, the ability characteristic may be the information indicating the level of athletic ability.

Also, the desired condition is not limited to the location area, but may be other conditions. The conditions which can be set by the present system for the school search (FIG. 4), may be utilized as the desired condition for the route school search.

Next, the system carrying out the above searching process will be explained.

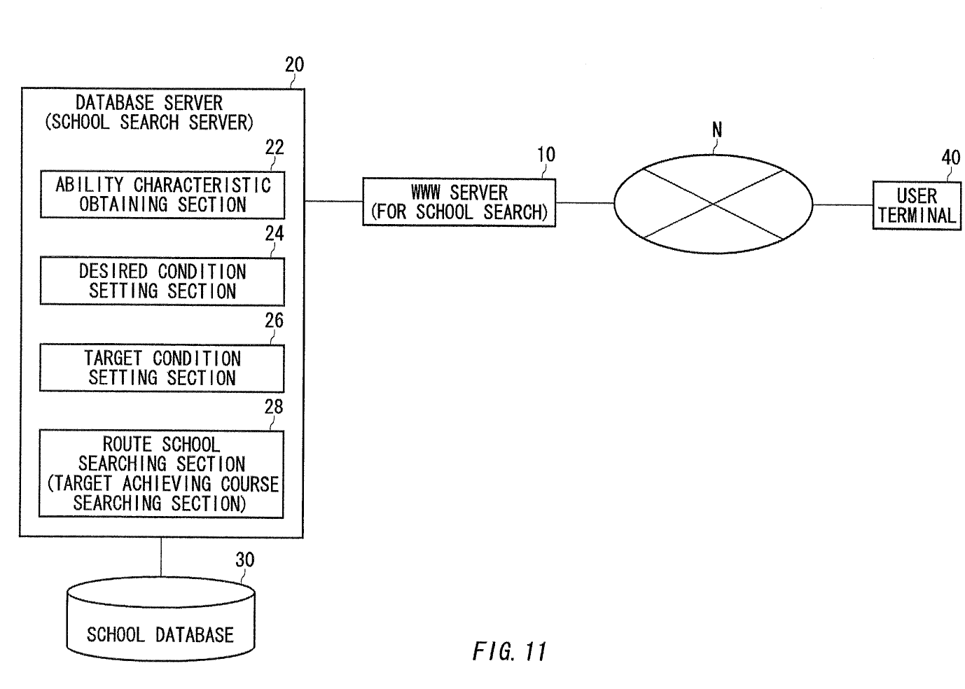

FIG. 11 is a part of the school searching system of FIG. 1, and shows a part mainly relating to search of the route school or intermediate school for achieving the target. As already explained by FIG. 1, the school searching system 1 includes a WWW server 10 and database server 20 (school searching server). The WWW server 10 may be accessed by the user terminal 40. The database server 20 receives the information necessary for searching the route school from the user terminal 40 through the WWW server 10. Then, the database server 20 searches the route school by using the database 30.

The database server 20 has an ability characteristic obtaining section 22, a desired condition obtaining section 24, and a target condition setting section 26. The ability characteristic obtaining section 22 obtains the percentile level as the ability characteristic of the searching student. The desired condition obtaining section 24 obtains the area of location of the school as the desired condition of the searching student. Further, the target condition setting section 26 obtains the target occupation of the searching student, and the target condition is set to the target occupation.

The WWW server 10 transmits to the user terminal 40 the information to indicate on the input page of the percentile level, desired location area and target occupation. The user inputs information on the input page, and the input information is sent to the WWW server 10, and provided to the database server 20.

The user, however, may not be the searching student himself, but a guardian of the searching student, for example.

Also, the location area may be input by the name of the area or in other forms, for example, the address of the searching student and desired time of attending the school. The location area is specified by both items of information.

Also, as an application example, the percentile level information may be obtained in the following manner. The WWW server 10 transmits examination questions which are the basis of calculation of the percentile level to the user terminal 40. The examination questions sent by HTML format are displayed on the user terminal 40. Answers input by the searching student are sent to the WWW server 10. the WWW server 10 or a database server 20 grades the test and calculates the percentile level. The percentile level criteria table for corresponding to the number of points of the percentile may be used. The percentile level so calculated may be obtained by the ability characteristic obtaining section 22. With such a configuration, this searching system becomes easy to use, even if the searching student is not aware of his own percentile level.

Returning to the explanation of FIG. 11, the database server 20 also has the route school searching section (a target achieving course searching section) 28. The route school searching section 20 searches an appropriate school from the school database 30 according to the process or method explained in FIG. 10 based on the ability characteristic, desired conditions and target condition.

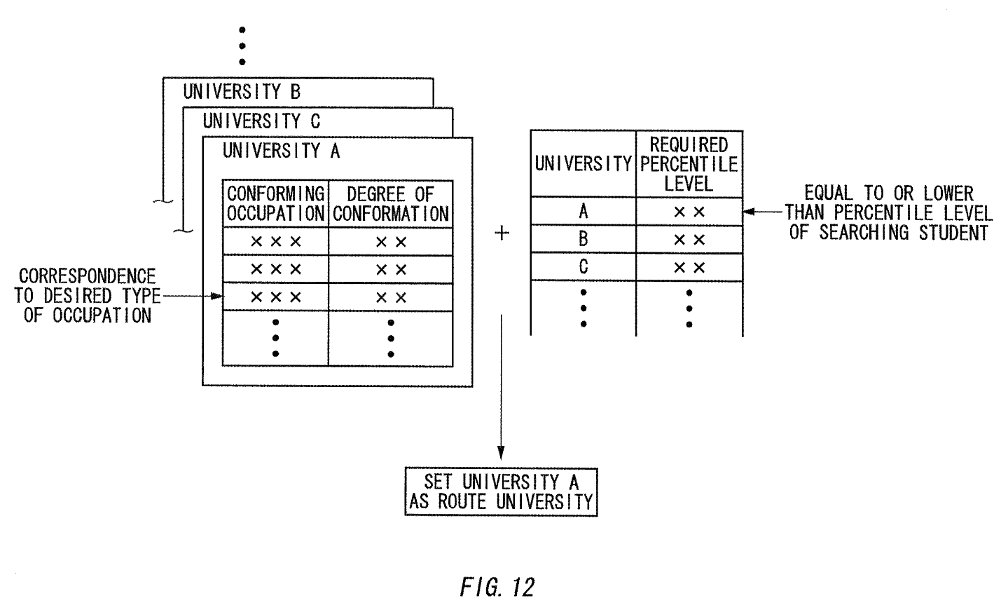

FIG. 12 shows an example of the route school searching process using the data of the school database 30. Here a university is searched as the route school.

As shown in FIG. 12, the conforming occupation and conforming degree are determined in advance in the school database 30 regarding each university. The conforming occupation is the occupation considered to be suited for the subject university. For example, the occupation taken by a comparatively large number of graduates of the subject university is set as the suitable occupation. The degree of conformity is information representing the extent of conformity of the subject university and suitable occupation, and may be an optional parameter showing such information. The degree of conformity may be the conformity of progress from the university to the next stage, or the conformity between adjacent stages. An appropriate conformity degree is determined in advance, and recorded in the database. Also, as shown in FIG. 12, the school database 30 memorizes the required percentile level of each university. The required percentile level is the level required for advancing to the subject university.

In the searching process, the occupation set as the target and appropriate occupation of each university are compared, and when the target occupation and appropriate occupation are met, the subject university is selected as a candidate route university. The required percentile level of these plural number of candidate route universities is used as reference. Then, the candidate route universities are narrowed down to universities having the required percentile level equal to or lower than the percentile level of the searching student. In the case of limiting the number of route universities, the degree of conformity is used as reference. Then, the prescribed number of route universities is chosen from among universities in the order of those having a greater degree of conformity. A university having the conformity degree equal to or more than the predetermined value may be selected.

According to the above process, if the required percentile level of a school is equal to or lower than the percentile level of the searching student, the school is determined as conforming to the ability of the searching student. Contrary to the above, if the required percentile level is equal to or lower than the percentile level of the searching student, and if the difference of both is equal to or lower than the predetermined threshold, the school may be determined as conforming. Alernatively, if the required percentile level is included in the above or lower prescribed limit percentile level of the searching student, the school may be determined as conforming.

Also, in the above process, the conforming occupation conforming to the school is set in the table of each school. Contrary to the above, for each occupation, a table may be prepared in order to select a school suitable for the occupation. In summary, a university and occupation suitable to the university are related in any form in the database (this is the same in the process below).

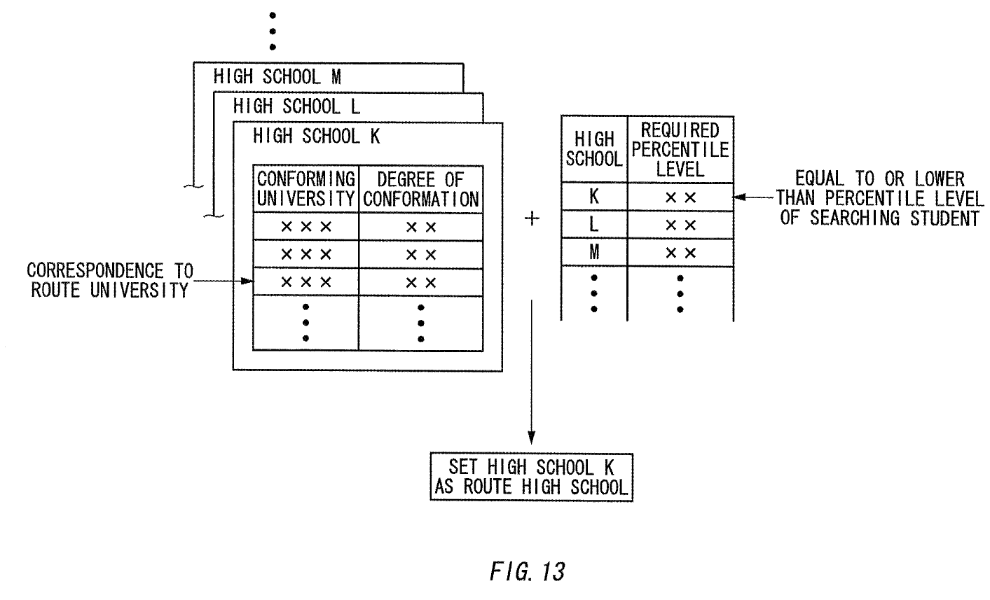

FIG. 13 shows an example of processing in searching a high school as the route school. As depicted in FIG. 13, in the school database, each high school is related to a university appropriate to the high school. Furthermore, the conforming level to each conforming university is appropriately determined. Also, the required percentile level of each high school is recorded in the database. As the searching process depicted in FIG. 13 is basically similar to the university searching process of FIG. 12, the detailed explanation is omitted. The searching process shown in FIG. 13 is used when the searching student is a middle school student or grade school student.

Moreover, it is preferable to determine in advance the conforming university and conforming level in FIG. 13, similar to the suitable occupation of FIG. 12. For example, a university having many students from a certain high school is determined as the conforming university. Also, the abovementioned conforming university and conforming level may be sought based on the respective required percentile level of the university and high school. For example, according to the standards of the required percentile level of a high school, a university having the required percentile level close to the standards (the margin of difference of the required percentile level is equal to or lower than the prescribed threshold) is a conforming university. Furthermore, the conformation degree is determined depending on the difference of required percentile level.

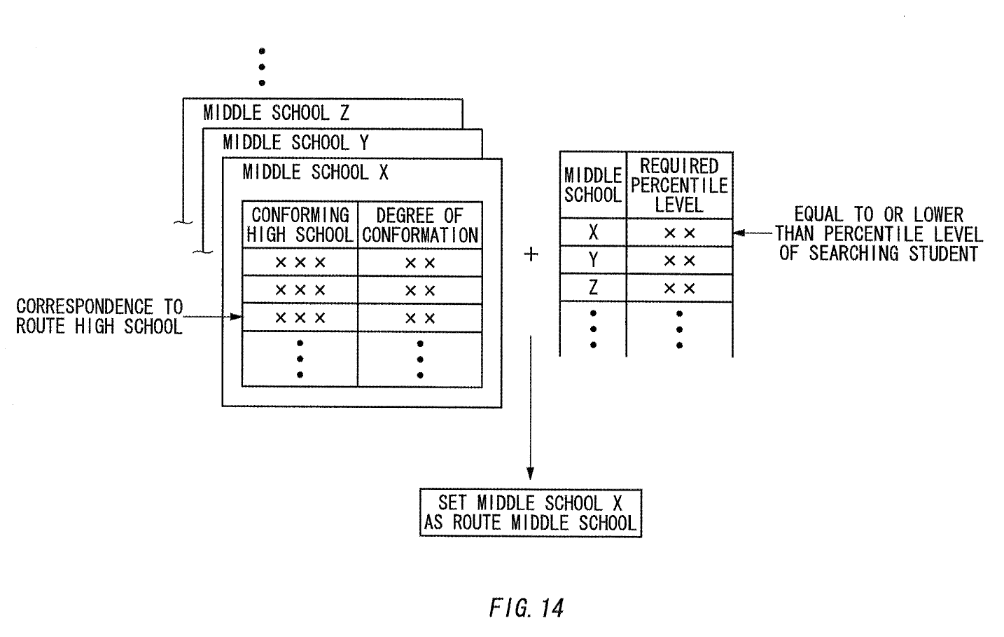

Furthermore, FIG. 14 shows an example of a searching process for a middle school as the route school. The information and processing of the database shown in FIG. 14 are basically similar to the abovementioned FIG. 13 except the difference of academic stage, so the detailed explanation is omitted. FIG. 14 is used in the case where the searching student is a primary school student.

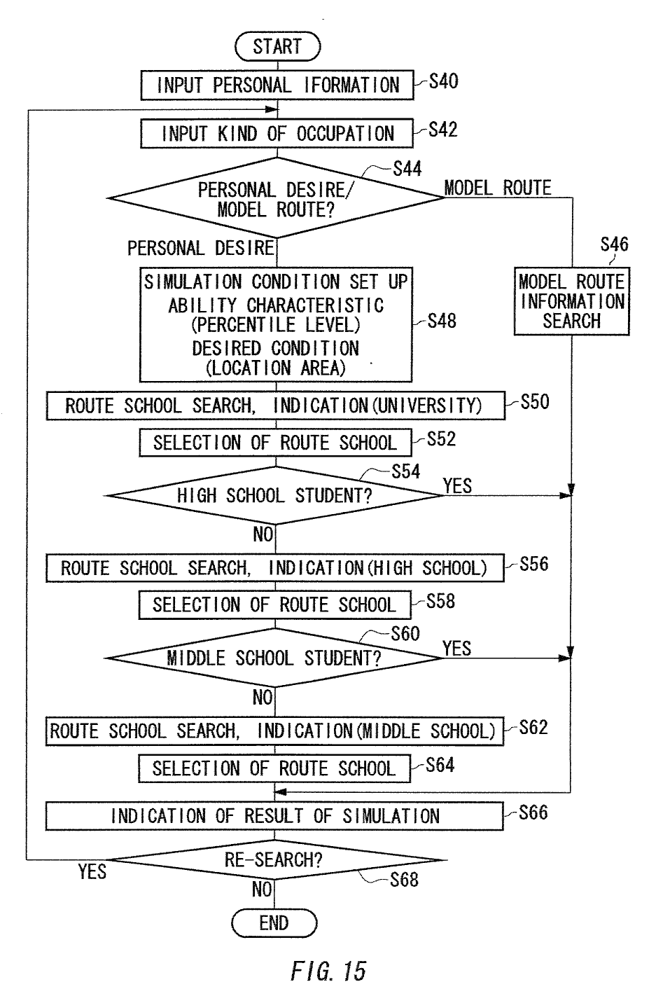

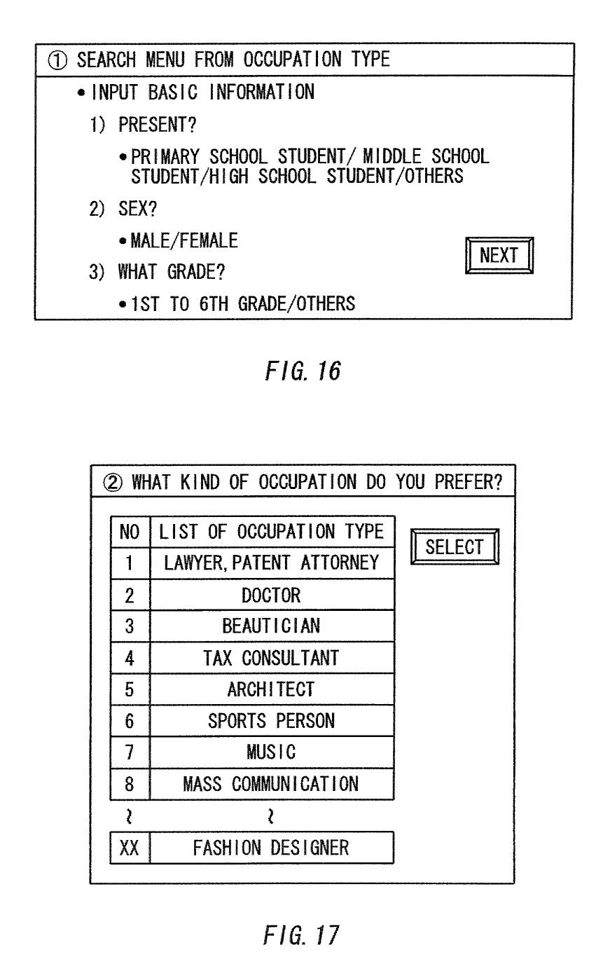

FIG. 15 is a flow chart showing a preferred example of the searching process for searching the route school and target achieving course. Also, FIG. 16 through FIG. 23 are examples of images displayed on the terminal equipment by processing of FIG. 15.

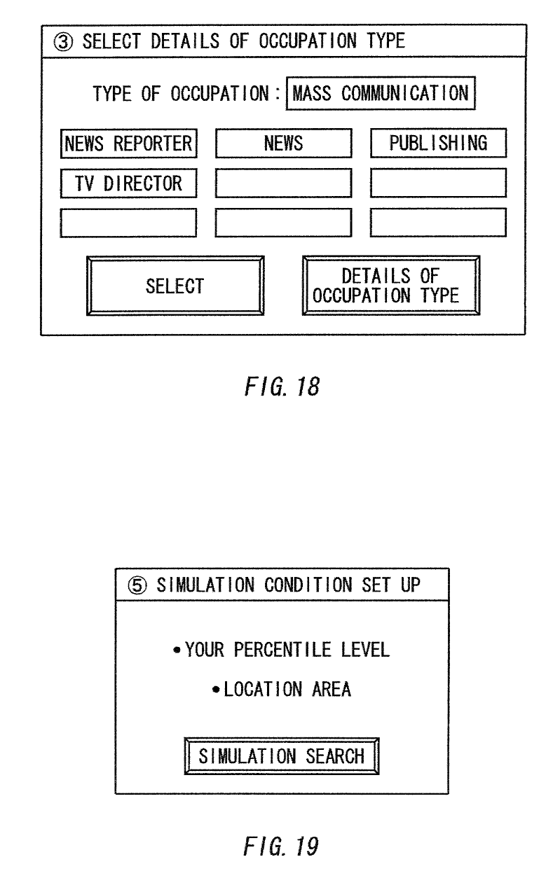

In FIG. 15, personal information of the searching student is input (S40). The personal information is input by using the input display of FIG. 16. The personal information includes current academic stage, sex and grade. Next, a desired type of occupation is input as the target condition (S42). FIG. 17 and FIG. 18 show the input display for selecting the desired type of occupation. At first, the display indicating a major classification of the desired type of occupation is shown, and the type of occupation in the major classification is selected (FIG. 17). Next, the display in which the list of types of occupation in the minor classification belonging to the type of occupation of the selected major classification is shown (FIG. 18). From among types of occupation of minor classification, the target type of occupation is selected.

When a button for details of types of occupation is clicked in the display of FIG. 18, the detailed explanation of the types of occupation is displayed. The detailed explanation includes, for example, content of type of occupation, academic route to reach the type of occupation (including the acquisition of qualifications), present number of applicable persons, average annual income, amount of money required to be expended to assume the type of occupation, course and subject of study, etc.

Returning to FIG. 15, when the desired type of occupation is selected by S42, it advances to S44 where either of personal desire route or model route to be displayed is selected. If the model route is selected by S44, the information of the model route to desired type of occupation is searched from the database (S46), and advanced to S66. At S66, the model route is indicated, and further the analytical information on possibility of assuming the desired type of occupation by following the model route of attending the optimum course of middle school-high school-university/vocational school is indicated.

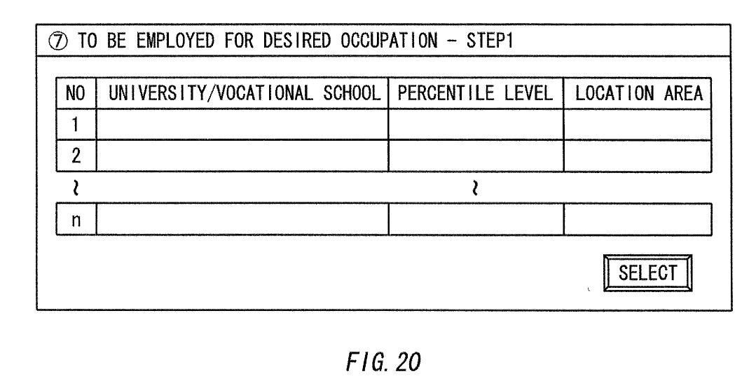

If the personal desire route is selected by S44, it advances to S48 and the simulation condition is set. By using the input display of FIG. 19, the percentile level and location area is entered as the simulation condition. The information is given to the database server 20 through WWW server 10 as the ability characteristic and desired condition respectively. The database server 20 searches the appropriate route school from the school database 30 based on the target occupation (desired occupation), ability characteristic (percentile level) and desired condition (location area)(S50). The process here is as explained by using FIG. 12, and the number n of route universities conforming to the desired type of occupation are selected. The information on these route universities is transmitted to the WWW server 10 from the database server 20. The WWW server 10 prepares the list of appropriate route universities in HTML form. This list is sent to and shown on the user terminal 40. In doing so, the list of appropriate schools to assume an appropriate kind of occupation is shown as indicated in FIG. 20.

Upon observing the list, the searching student may request the detailed information of optional route schools. This demand is transmitted to the database server 20. The detailed information of the school is read out from the school database 30 and transmitted to and indicated on the user terminal 40. The detailed information is as explained by using FIG. 6 and FIG. 7. Furthermore, the number of graduated students who assumed their desired occupation in the past, transition in each year, and famous graduates in the desired type of occupations may be indicated.

Furthermore, the searching student selects the desired university upon viewing the list of universities which are route schools (S52). In response to this, the WWW server 10 determines whether or not the searching student is a high school student (S54). In the case of a high school student, processing advances to S66 as no further search is necessary.

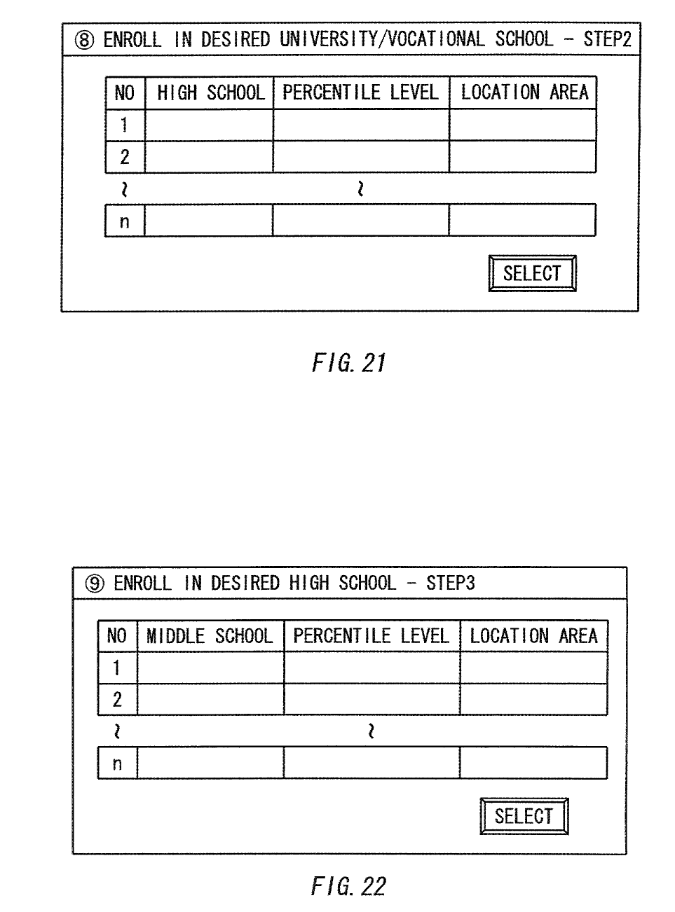

When the searching student is not a high school student, processing advances to S56 and the next route school is searched. That is to say, a suitable high school is searched as the route school. Here, a route high school conforming to the route university selected in S52 is searched. The number n of route high schools is searched, and a list of such route high schools is indicated. As indicated in FIG. 21, the list of appropriate high schools to enter in the desired university/vocational school is indicated. Similar to the university, in response to the demand of the searching student, the detailed information of the route high school is indicated.

When a searching student select one of route high schools (S56), the WWW server 10 advances to S60 and the WWW server 10 determines whether or not the searching student is a middle school student. In the case where the searching student is a middle school student, processing advances to S66 as no further search is necessary.

When the searching student is not a middle school student, that is, when the searching student is a grade school student, the process advances to S62, and a middle school is searched as a route school. The number n of middle schools are searched and indicated. As shown in FIG. 22, the list of suitable middle schools to enter into the desired high school is indicated and one of the middle schools is selected (S64). The processing of S62 and S64 is basically similar to S56 and S58. The detailed information on optional schools is provided. After the selection of S64, processing advances to S66. At S66, the simulation result obtained from the above is indicated.

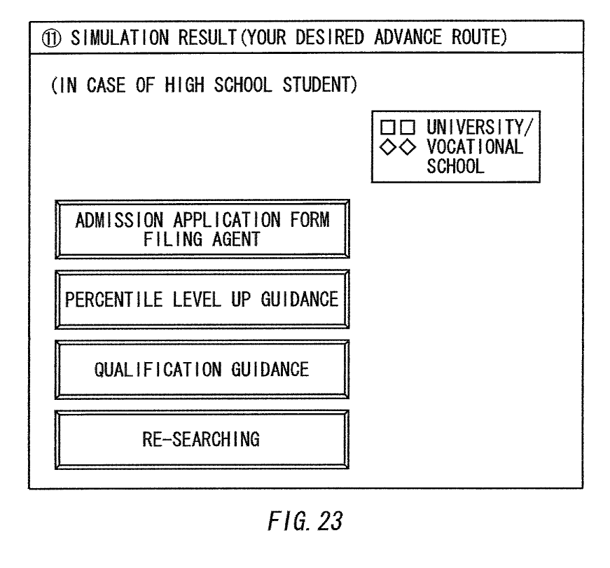

FIG. 23 through FIG. 25 show examples of indicating the simulation results. FIG. 23 is an example of the simulation result display when the searching student is high school student (FIG. 15, S54, Yes). An appropriate route university is indicated. The icon for the “admission application form filing agent”, “percentile level up guidance” and “qualification guidance” is provided on the display. When any of these icons is clicked, the applicable process is performed.

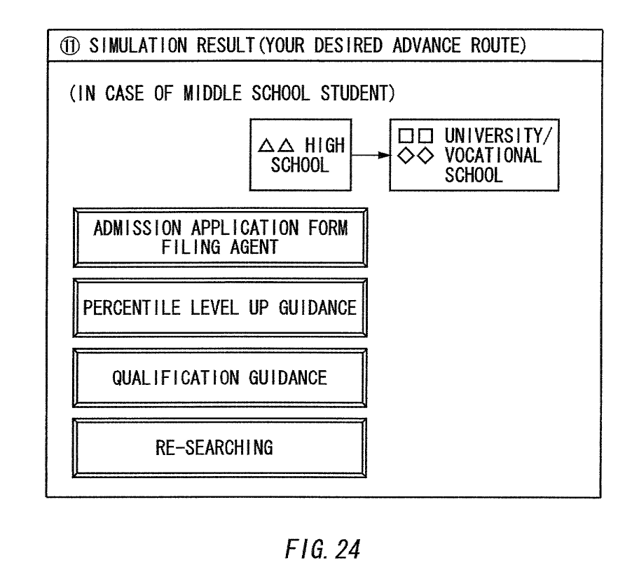

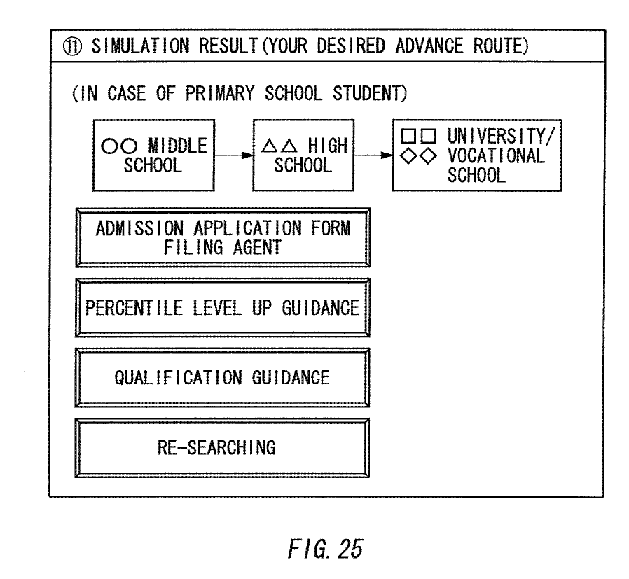

Similarly, FIG. 24 is an example of the simulation result display when the searching student is a middle school student (FIG. 15, S60, Yes). An appropriate route university and route high school are indicated. FIG. 25 is an example of the simulation result display when the searching student is a primary school student (FIG. 15, S60, No.). An appropriate route university, route high school and route middle school are indicated. The icon for the “admission application form filing agent”, “percentile level up guidance” and “qualification guidance” is provided on the display. When any of these icons is clicked, the applicable process is performed. Depending on the operation of the icons, the applicable process is performed.

On the simulation result display of FIG. 23 through FIG. 25, there is further provided an icon of “re-searching (to redo the simulation search)”. When this icon is clicked, the judgment of S68 becomes Yes, and processing returns to S42. When S68 is No. the process is terminated.

Above is the searching process shown in FIG. 15. In the above explanation, although the search result, including route school and target achieving course, is mainly output using display of the user terminal, the search result may be output using a printer provided with the user terminal, the result may be output to a memory device such as a hard disk which may be provided on the user terminal, or any another output device, including a communication device, can be applied to provide the search result to the user.

“Processing of consecutive school group (attached school)”

In the present embodiment, the consecutive school group means a group of schools belonging to adjacent plural intermediate academic stages (steps) and constituting schools each having continuity. The consecutive school group is typically schools which substantially require no examination when moving up to the upper stage from the lower stage. Typically, this is a combination of schools having an affiliation relationship. There are three kinds of such school groups, namely, middle school-high school, high school-university, and middle school-high school-university. For the consecutive school group, the following process is performed.

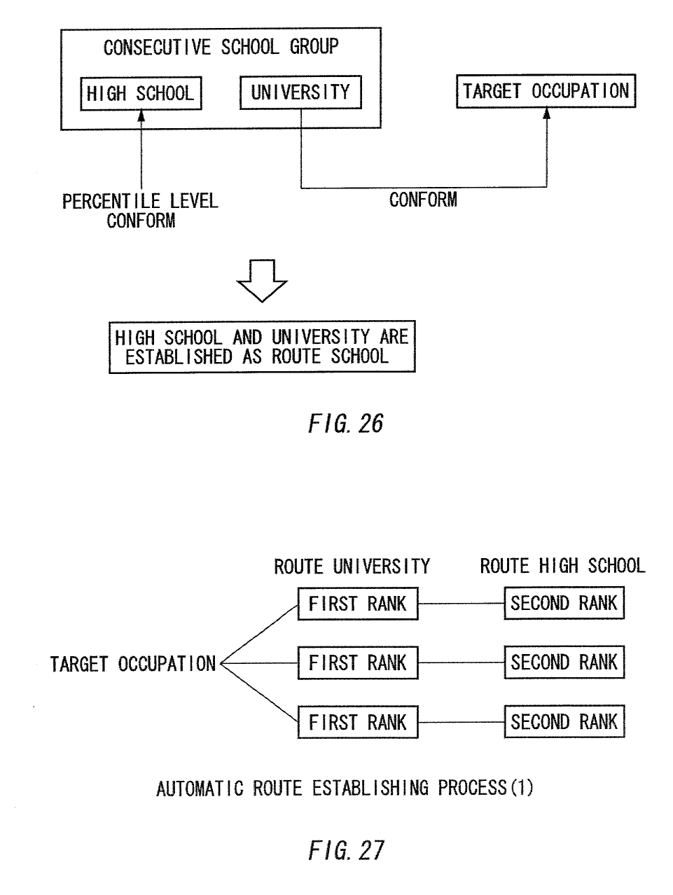

FIG. 26 is an example of processing the consecutive school group. As an example of the consecutive school group, the combination of a university and a high school is considered. (1) In the route school searching process, the university constituting the consecutive school group is considered and it is determined whether or not the university conforms with the target occupation. For this determination, the conforming occupation of the university constituting the school group is stored in the database similar to other universities. (2) Furthermore, the high school constituting the consecutive school group is considered, and whether or not the required percentile level of the high school is satisfied by the percentile level of the searching student is determined. When the above two conditions are satisfied, the university and high school constituting the consecutive school group are selected together as the route schools.

The above process also applies similarly to the searching student who is a grade school student. In such a case, after the university and high school of the consecutive school group are set as the route school, a middle school appropriate for the route high school is to be searched. Furthermore, the above process is also applied similarly to other consecutive school groups (middle school-high school, middle school-high school-university).

As explained by using FIG. 26, as for the consecutive school group, whether or not the route school at a lower stage constituting the consecutive school group conforms to the ability characteristic is determined. Whether or not the route school of the upper stage conforms to the condition of the next stage is also determined. When two conditions are satisfied, the school constituting the consecutive school group is selected as the route school forming the target achieving course. Therefore, the preferred process of the present invention regarding the target achieving is applied to the consecutive school group.

“Automatic searching process of the target achieving course”

By the process of the above FIG. 15, for example, plural number of route universities are offered to users, and the selection of one of the route universities is prompted. The similar demand for selection is also issued for the route high school and route middle school. Accordingly, the target achieving course is established semi-automatically. The target achieving course may be established automatically as mentioned below.

FIG. 27 is an example of the automatic course setting process. Assume that the searching student is a middle school student. As explained by using FIG. 12 to FIG. 14 inclusive, with this embodiment, the conforming degree is set in relation to the condition of the next stage (target condition or route school). The course is set using this conformation degree. As for the example of FIG. 27, the university having the greatest degree of conformity with the target occupation is selected as the route university. When the route high school is selected, the conformation degree with the route university which is already set is used. Three high schools are selected, according to the order of having greater conforming degree. In these selection processes, the school which satisfies the required percentile level and desired location area is of course selected. As stated above, three kinds of route school sets (high school and university) forming the optimum target achieving course can be obtained.

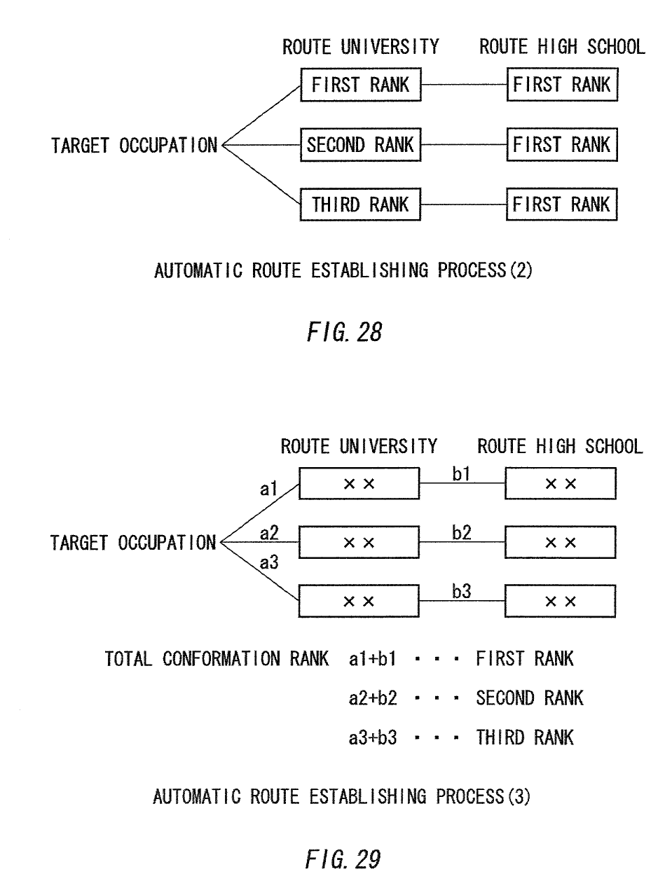

FIG. 28 is one more example of the automatic course setting process. With this process, universities having the conformation degree of the first to third rank are selected. The high school having the major conformation degree is searched respectively covering the three route universities. Here, the school which satisfies the required percentile level and desired location area is selected. As described, three kinds of route school sets (high school and university) forming the target achieving course which are considered to be most appropriate, are obtained.

FIG. 29 is one more example of the automatic course setting process. With this process, the number n of route universities are sought. Each route university has the conformation degree against the target occupation. Furthermore, the route high school having the optimum conformation degree with each route university is sought. By doing so, the number n of combinations of route university-route high school is obtained. For each combination, the total of conformation degree of universities and high school is sought (a1+b1, a2+b2 , , , ). Three sets of combinations are selected in the order of greater total conformation degree. Each of these combinations is offered as the target achieving course.

“Search for target achieving course based on easy accessibility”

Next, another embodiment of this invention will be explained. In this embodiment, the route school on the target achieving course is searched by taking into consideration the easy-accessibility to the target condition.

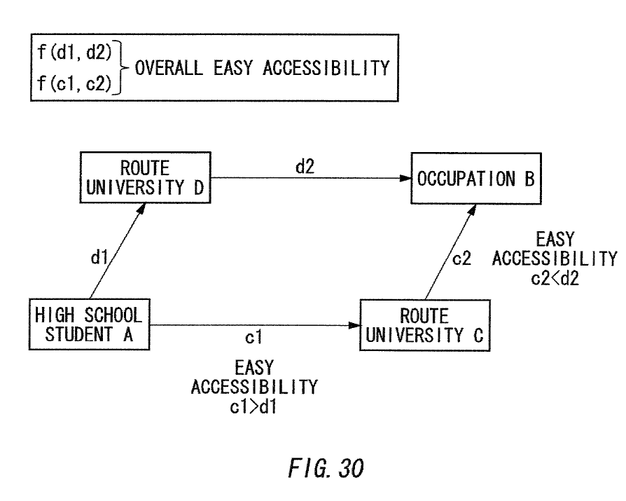

FIG. 30 schematically shows a process of this embodiment. It is assumed that the searching student as a high school student A, the target condition is the occupation B, and the candidate route university is the university C and university D.

In this embodiment, the easy accessibility from the present condition to the universities C and D (c1, d1) is considered. Furthermore, the easy accessibility from the universities C and D to the target condition (c2 and d2) is considered. It is assumed that the easy accessibility from the present condition to the university C is greater than the university D (c1>d1), and that the easy accessibility from the university C to occupation B is smaller than the university D (c2<d2, more difficult).

Under the above condition, although the university D is difficult, since the employment subsequent to the university is easy, the access to the target may be easy overall. On the contrary, if entering the university C that is easier to enter, there may be a case where the accessibility to the final target is easy. It is difficult to determine at a glance, which is more advantageous.

In this embodiment, the easy-accessibility to a whole course up to the target is obtained from the easy accessibilities of moving to each stage or step (high school to university, university to occupation). That is to say, the easy accessibility is sought in order for the high school student A to enroll in the university C and to assume the occupation B. Similarly, the easy accessibility is sought in order for the high school student A to enroll in the university D and to assume the occupation B. By comparing the easy accessibility of these courses as a whole, it may be determined which university should be selected to assume the target occupation.

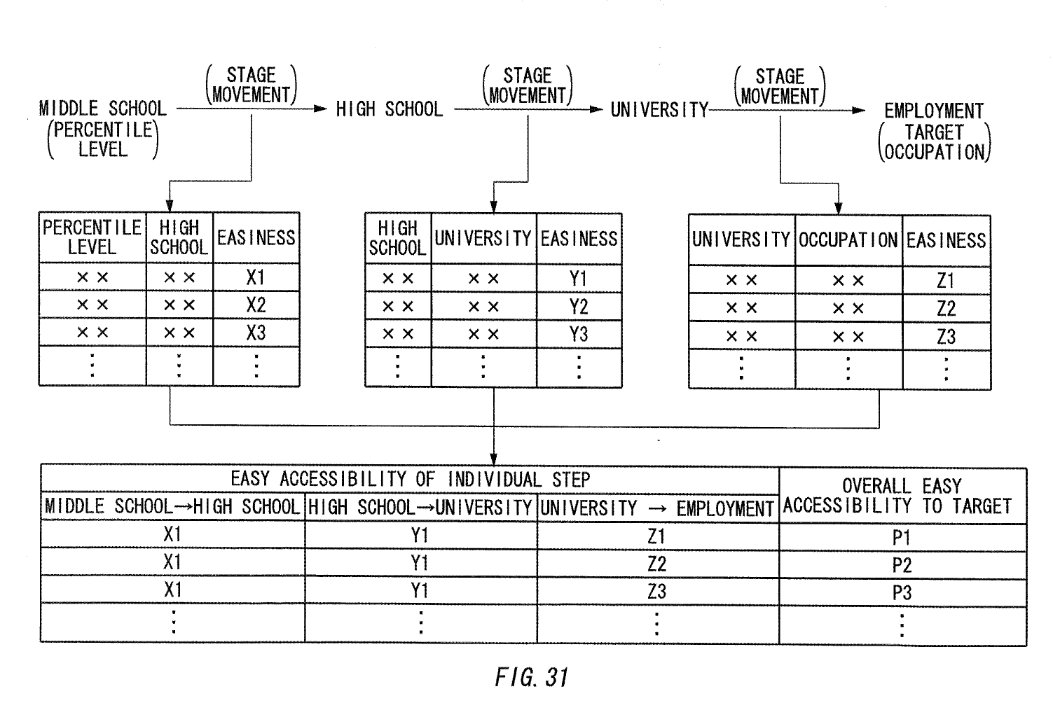

FIG. 31 shows an example of a searching process for the route school in this embodiment. Here, the current academic stage is the middle school and the target stage is an occupation. Then, the easy-accessibility from the middle school to the employment is considered.

As shown in FIG. 31, between the middle school and employment, there are three stage movements respectively to three stages (from middle school to high school, high school to university, and university to employment). For each move of stage, the easy accessibility is sought concerning various schools.

First, the first stage of movement (from middle school to high school) is noted. As indicated by the table in FIG. 31 (left), in the school database 30, the easy accessibility to each high school is determined in relation to the percentile level and a high school. The easy accessibility is set corresponding to the difference between the required percentile level of the high school and the percentile level of the searching student. From this table, the easy accessibility corresponding to the combination of the percentile level of the searching student and each school may be obtained.

Next, the second stage of movement (from high school to university) is noted. As indicated by the table in FIG. 31 (middle), the school database 30 determines the easy accessibility corresponding to many combinations of universities and high schools. The easy accessibility between schools may be seen in the form of a parameter representing the conforming level of the upper stage school with the lower stage school. In the example of FIG. 31, the smaller the difference between “required percentile level of university” and “required percentile level of high school” (includes the negative value), the greater the level at which easy accessibility is set.

The above is also the same in the third stage movement (from university to employment). As indicated by the table in FIG. 31(right), the school database 30 prescribes the easy accessibility corresponding to many combinations of occupations and universities. Here, the easy accessibility may be observed as a form of parameter representing the conformation degree of an occupation to a university. By considering the occupation and required percentile level of the university, the easy accessibility may be set such that it becomes larger as the required percentile level becomes greater.

Furthermore, as shown in FIG. 31(lower), the table for seeking an overall easy accessibility is prepared from the easy accessibility of each movement to three stages in the school database 30. By using these tables, the following search process is carried out.

With the search processing, the combinations of the percentile level, high school, university and occupation are selected. The percentile level and occupation are fixed, but many candidates are set for the high school and university. Accordingly, many combinations may be subjected to the search. For each combination, the easy accessibilities at the above three stages of movement are sought. Furthermore, by applying these easy accessibilities to the table of FIG. 31(lower), the easy accessibility of the whole course from the middle school to the employment is obtained. The combination which has the greatest easy accessibility for the whole route is selected. Alternatively, a predetermined number of combinations is selected in the order of the overall easy accessibilities. The high school and university constituting the selected combination are chosen as the route schools.

As stated above, according to the present embodiment, the route school through which the searching student may easily achieve the target is searched.

Moreover, in this embodiment, it may be appropriate to consider the condition desired by the searching student. The desired condition is, for example, the location area. Then, the route school which conforms to the desired condition is searched.

Also, in this embodiment, it is preferable to search the route school by taking into consideration the consecutive school group (attached school, etc.). In this case, the easy accessibility between schools of the consecutive school group is set properly, and it is preferably set at a minimum by comparing the easy accessibility between schools other than those of consecutive school group. In doing this, the searching process of this invention may be easily applied to those of a consecutive school group.

Also, the process based on the easy accessibility of this embodiment may be combined with the process of FIG. 10. For example, by utilizing the process of FIG. 10, plural candidate route schools may be sought. Furthermore, based on the overall easy accessibility from the present to the target, the candidates of the route school are narrow down. Through such process, an appropriate route school may be obtained.

As described above, according to the present invention, an appropriate school for achieving the target of the searching student, such as a student taking an examination, is searched, and useful information may be provided to the searching student.

The invention has been explained by using the embodiments above, but the technical scope of the invention is not limited to the scope described in the embodiment. It is clear from the scope of the appended claims that embodiments to which various modifications and improvements are added may be included within the technical scope of the subject invention.

What is claimed is:

1. A school searching method for searching information concerning schools conforming to the searching student comprising:
obtaining an ability characteristic indicating ability level in a current academic stage of the searching student;
setting a target condition in a target stage of the searching student; and
searching at least one route school located in a intermediate academic stage between said current academic stage and said target stage, said at least one route school conforming to said ability characteristic and forming a target achieving course suitable for the searching student to reach said target condition.

2. The method according to claim 1, wherein the step of searching the route school comprises searching the route school conforming to the ability characteristic as well as the condition for a next stage, in a direction reverse to the academic progressing direction, with the target stage as the starting point.

3. The method according to claim 1, wherein the step of searching the route school comprises selecting a school constituting a consecutive school group as the route school forming the target achieving course, said consecutive school group constituting schools belonging to a plurality of intermediate academic stages adjacent to each other and each having continuity, and wherein the school constituting the consecutive school group is selected as the route school when the lower stage school of the consecutive school group conforms to the ability characteristic and when the upper stage school of the consecutive school group conforms to the condition of next stage.

4. The method according to claim 1, wherein the step of searching the route school comprises searching the route school based on easy-accessibility of the whole target achieving course obtained from easy-accessibility of each stage movement between the current academic stage and the target stage.

5. The method according to claim 1, wherein said target condition of said target stage is an occupation in an employment stage.

6. The method according to claim 1, wherein said target condition of said target stage is a university in a university stage.

7. The method according to claim 1, further comprising obtaining a desired condition indicating desire of the searching student with respect to the route school, wherein the step of searching the route school comprises searching the route school conforming to said desired condition.

8. The method according to claim7 wherein said desired condition includes location of the route school.

9. A school searching apparatus for searching information concerning schools conforming to the searching student comprising:
an ability characteristic obtaining section for obtaining an ability characteristic indicating ability level in a current academic stage of the searching student;
a target condition setting section for setting a target condition in a target stage of the searching student; and
a route school searching section for searching at least one route school located in an intermediate academic stage between said current academic stage and said target stage, said at least one route school conforming to said ability characteristic and forming a target achieving course suitable for the searching student to reach said target condition.

10. The apparatus according to claim 9, wherein the route school searching section searches the route school conforming to the ability characteristic as well as the condition for next stage, in the direction reverse to the academic progressing direction, with the target stage as the starting point.

11. The apparatus according to claim 9, wherein the route school searching section selects a school constituting a consecutive school group as the route school forming the target achieving course, said consecutive school group constituting schools belonging to a plurality of intermediate academic stages adjacent to each other and each having continuity, and wherein the school constituting the consecutive school group is selected as the route school when the lower stage school of the consecutive school group conforms to the ability characteristic and when the upper stage school of the consecutive school group conforms to the condition of a next stage.

12. The apparatus according to claim 9, wherein the route school searching section searches the route school based on easy-accessibility of the whole target achieving course obtained from easy-accessibility of each stage movement between the current academic stage and the target stage.

13. The apparatus according to claim 9, wherein said target condition of said target stage is an occupation in an employment stage.

14. The apparatus according to claim 9, wherein said target condition of said target stage is a university in a university stage.

15. The apparatus according to claim 9, further comprising a condition obtaining section for obtaining a desired condition indicating desire of the searching student with respect to the route school, wherein the route school searching section searches the route school conforming to said desired condition.

16. The apparatus according to claim 15 wherein said desired condition includes location of the route school.

17. A school searching apparatus for searching information concerning schools conforming to the searching student comprising:
means for obtaining ability characteristic indicating ability level in a current academic stage of the searching student;
means for setting a target condition in a target stage of the searching student; and
means for searching at least one route school located in a intermediate academic stage between said current academic stage and said target stage, said at least one route school conforming to said ability characteristic and forming a target achieving course suitable for the searching student to reach said target condition.

18. A school searching system comprising:
a school searching WWW server which may be accessed by the user terminal used for the searching student; and
a school searching server to search information regarding the school conforming to the searching student based on the information of the searching student acquired from the user terminal through the school searching WWW server, said school searching server including: an ability obtaining section for obtaining ability characteristic indicating ability level in a current academic stage of the searching student; a target setting section for setting a target condition in a target stage of the searching student; and a route school searching section for searching at least one route school located in an intermediate academic stage between said current academic stage and said target stage, said at least one route school conforming to said ability characteristic and forming a target achieving course suitable for the searching student to reach said target condition, wherein said school searching WWW server provides the information of the searching result obtained from said school searching server to the user terminal after processing the information for providing it to the user terminal.

19. A program capable of being executed by a computer, the program causing the computer carry out:
obtaining an ability characteristic indicating ability level in a current academic stage of the searching student;
setting a target condition in a target stage of the searching student; and
searching at least one route school located in an intermediate academic stage between said current academic stage and said target stage, said at least one route school conforming to said ability characteristic and forming a target achieving course suitable for the searching student to reach said target condition.

20. A recorded medium storing a program executable by a computer, said program causing the computer to carry out:
obtaining an ability characteristic indicating ability level in a current academic stage of the searching student;
setting a target condition in a target stage of the searching student; and
searching at least one route school located in a intermediate academic stage between said current academic stage and said target stage, said at least one route school conforming to said ability characteristic and forming a target achieving course suitable for the searching student to reach said target condition.
